(19) United States
(12) Patent Application Publication
(10) Pub. No.: US 2011/0241345 A1
(43) Pub. Date: Oct. 6, 2011

(54) EXPANDABLE MULTI-SET CIRCULATION HYDROELECTRIC POWER GENERATION METHOD AND SYSTEM

(76) Inventor: Weiping Chen, Guangdong (CN)

(21) Appl. No.: 13/061,707

(22) PCT Filed: Sep. 9, 2008
(86) PCT No.: PCT/CN08/72299

§ 371 Date: Mar. 2, 2011

(51) Int. Cl. H02K 7/18; F03B 17/04

(52) U.S. Cl. 290/52; 415/916

(57) ABSTRACT

An expandable multi-set circulation hydroelectric power generation method and system. The system includes a power station control area (A), a transformer substation area (B), a circulation cistern (C) provided with a plurality of small cisterns (CA1 to CA20). Gates (E1 to E20) and protection screenings are installed in the small cisterns (CA1 to CA20). A water pump set station area is provided with a plurality of water pump sets (D1 to D20). The water pump sets (D1 to D20) are connected to the small cisterns (CA1 to CA20). The small cisterns (CA1 to CA20) are connected to pressure pipes (G1 to G20). The pressure pipes (G1 to G20) are connected to work done pipes (H1 to H10). A plurality of water turbine generator sets (F1 to F51) and a plurality of gates (E42, E43, E47, E50, E53, E56, E59, E63, E64, E65) are installed in the work done pipes (H1 to H10).

### FIELD OF THE INVENTION

The present invention relates generally to an electric power generating method, and more specifically, to an expandable multi-set circulation hydroelectric power generation method and system, which is clear, recyclable, renewable without consumption of energy, and which needs low investment while generating much electric power, and can generate electric power when still in construction.

### BACKGROUND OF THE INVENTION

In conventional electric power generation methods, generally rivers are dammed up to generate electric power, or water reservoirs are built to generate electric power. In these conventional methods, upstream water are introduced to a water turbine generator set via pressure pipes to generate electric power. Such methods need large investment but low profit, and waste resources. Coal-fired and oil-fired power generation populate environment. Nuclear power stations provide clear energy, but large investment is needed and the profit is low, and danger for nuclear power station is inestimable. Gas-fired power generation also needs large investment and wastes resources. Other power generation methods such solar energy, wind energy, and biomass energy etc., are unable to be widely popularized due to high cost and difficulty of technical development, and fossil and oil are non-renewable resources. Energy shortage is a serious problem faced for human development. Countries all over the world are seeking for methods of replacing fossil and oil.

### SUMMARY OF THE INVENTION

Object of the present application is to provide an expandable multi-set circulation hydroelectric power generation method and system, which is clear, recyclable, renewable without consumption of energy, and which needs low investment while generating much electric power, and can generate electric power when still in construction.

In an aspect of the present application, an expandable multi-set circulation hydroelectric power generation method is provided, comprising a power station control area, a transformer substation area, a circulation cistern, a water pump set station, a pressure pipe, gates, work done pipes, water turbine generator sets, and a plant etc. Wherein, the plant has a water pump set station area, and the plant is provided with circuits, and exhaust pipes are arranged on the plant. The circulation cistern comprises a plurality of small cisterns having same spec and size, and each small cistern has a protection screening and a gate for facilitating installation and maintenance of the water pump sets. The water pump set station area comprises a plurality of water pump sets, wherein inlet pipes of the water pump sets are connected to the small cisterns in the circulation cistern via underground, and roads are paved over the inlet pipes for facilitating installation of the water pump sets; outlet pipes of the water pump sets have respective gates, and then connected to an inlet pipe of the pressure pipe, which has a outlet, a standby outlet, and also a standby gate. The work done pipes comprise a plurality of work done pipes, and each work done pipe has a plurality of gates for adjusting water flow direction and controlling switching on/of the pipes. In the work done pipes, a plurality of water turbine generator sets, and also emergency doors and underground drain are built. The work done pipes further have outlets which are connected to the circulation cistern, and standby outlets which are also connected to the circulation cistern. The inlets of the work done pipes are connected to the pressure pipe, and the outlet of the standby gate of pressure pipe is also connected to the work done pipes. Further, the work done pipes have standby gates for extension purpose. Sectional area of the pressure pipe is equal to one half of a sum of the sectional area of the outlet pipes of all the water pump sets. Sectional area of the inlet of each work done pipe is equal to two-third of the sectional area of the outlet of the pressure pipe, and the work done pipe has a same spec and size through its inlet to its outlet.

Roads are paved around the plant. Water flow direction is marked on the pressure pipe and the work done pipes for facilitating operation of the power station control area, the transformer substation area and the water pump sets. The pressure pipe, the work done pipes, the water turbine generator sets, the gates and the plant are buildings on the ground. The power station control area utilizes electric energy from the transformer substation area to initiate the plurality of water pump sets, then the water pump sets draw water from the circulation cistern and sent it to the pressure pipe to form water flow with a certain pressure. The water flow passes through the pressure pipe and then through the work done pipes and the assistant pipes. Direction of the water flow is controlled via the gates so as to enable the water turbine generator sets in the work done pipes running to generate electric power. The water flow in the work done pipes passes through the plurality of water turbine generator sets into the circulation cistern. Generating electric power whilst being in construction may be achieved through switching off the standby gates in the work done pipes, in such a way an infinite plurality of water turbine generator sets can be built up without any increase of energy consumption. The generated electric power is outward transferred by the transformer substation area except for satisfying self needing.

In an aspect of the present application, an expandable multi-set circulation hydroelectric power generation system is provided, comprising a circulation cistern used as water supply, water pump sets, a pressure pipe and work done pipes; wherein:

inlet pipes of the water pump sets are connected to the circulation cistern to pressure up water flow from the circulation cistern, and then the water flow is sent out by the outlet pipes of the water pump sets;

inlets of the pressure pipe are connected to the outlet pipes of the water pump sets to receive the pressured water flow and send it out through an outlet;

each work done pipe has a plurality of water turbine generator sets, wherein an inlet of the work done pipe is connected to the outlet of the pressure pipe to receive the pressured water flow which pushes the water turbine generator sets running, an outlet of the work done pipe is connected to the circulation cistern for water flowing into the circulation cistern via the outlet of the work done pipe.

In another aspect of the present application, an expandable multi-set circulation hydroelectric power generation method is provided, comprising: initiating a plurality of water pump sets to draw water from a circulation cistern to a pressure pipe to form pressured water flow; pushing a plurality of water turbine generator sets in a plurality of work done pipes to run by the pressured water flowing into the pressure pipe; driving respective power generator sets running by the water turbine generator sets to generate electric power; returning water flow after power generation into the circulation cistern.

By virtue of the method and system of the present application, generating electric power whilst being in construction is achieved, and it does not occupy resources. Therefore the method and system of the present application needs low investment and small area, but obtain high social benefit, and this is a kind of recyclable, clear and renewable green energy.

### BRIEF DESCRIPTION OF THE DRAWINGS

The accompanying drawings illustrate one or more embodiments of the present application and, together with the written description, serve to explain the principles of the present application, but not a restriction to the present application, and wherein:

FIG. 1 is a diagram illustrating a profile structure of an embodiment of the present application.

FIG. 2 is a diagram illustrating a structure of an embodiment of the present application.

FIG. 3 is a structural diagram illustrating circulation cistern, water pump sets and pressure pipes according to the present application.

FIG. 4 is a structural diagram illustrating water pump sets, gates and water turbine generator sets according to the present application.

FIG. 5 is a structural diagram illustrating work done pipes, water turbine generator sets, gates and emergency doors according to the present application.

FIG. 6 is a structural diagram illustrating work done pipes, water turbine generator sets, gates and emergency doors according to the present application.

FIG. 7 is a structural diagram illustrating work done pipes, water turbine generator sets, gates and emergency doors according to the present application.

In the drawings:

A power station control area;

B transformer substation area;

C circulation cistern;

CA small cistern, comprising CA1, CA2, CA3, CA4, CA5, CA6, CA7, CA8, CA9, CA10, CA11, CA12, CA13, CA14, CA15, CA16, CA17, CA18, CA19, CA20;

D water pump sets, comprising D1, D2, D3, D4, D5, D6, D7, D8, D9, D10, D11, D12, D13, D14, D15, D16, D17, D18, D19, D20;

DA inlets of the water pump sets

DB outlets of the water pump sets

E gate, comprising E1, E2, E3, E4, E5, E6, E7, E8, E9, E10, Ell, E12, E13, E14, E15, E16, E17, E18, E19, E20, E21, E22, E23, E24, E25, E26, E27, E28, E29, E30, E31, E32, E33, E34, E35, E36, E37, E38, E39, E40, E41, E42, E43, E44, E45, E46, E47, E48, E49, E50, E51, E52, E53, E54, E55, E56, E57, E58, E59, E60, E61, E62, E63, E64, E65, E66, E67, E68, E69, E70, E71, E72, E73, E74, E75, E76, E77, E78, E79;

F water turbine generator sets, comprising F1, F2, F3, F4, F5, F6, F7, F8, F9, F10, F11, F12, F13, F14, F15, F16, F17, F18, F19, F20, F21, F22, F23, F24, F25, F26, F27, F28, F29, F30, F31, F32, F33, F34, F35, F36, F37, F38, F39, F40, F41, F42, F43, F44, F45, F46, F47, F48, F49, F50, F51;

G pressure pipes, comprising G1, G2, G3, G4, G5, G6, G7, G8, G9, G10, G11, G12, G13, G14, G15, G16, G17, G18, G19, G20;

GA outlet pipe of the pressure pipes;

GB standby outlet pipe of the pressure pipes;

H work done pipes, comprising H1, H2, H3, H4, H5, H6, H7, H8, H9, H10;

H11, H12 assistant pipes;

HA inlet pipe of the work done pipes;

HB standby inlet pipe of the work done pipes;

HC standby outlet of the work done pipes;

HD outlet of the work done pipe H10;

M roads;

MA underground passage;

N plant;

O exhaust pipes, comprising O1, O2, O3, O4, O5, O6, O7, O8, O9, O10, O11, O12, O13, O14, O15, O16, O17, O18, O19, O20, O21, O22, O23, O24, O25;

P emergency doors of the exhaust pipes;

Q water flow direction

### DETAILED DESCRIPTION OF THE INVENTION

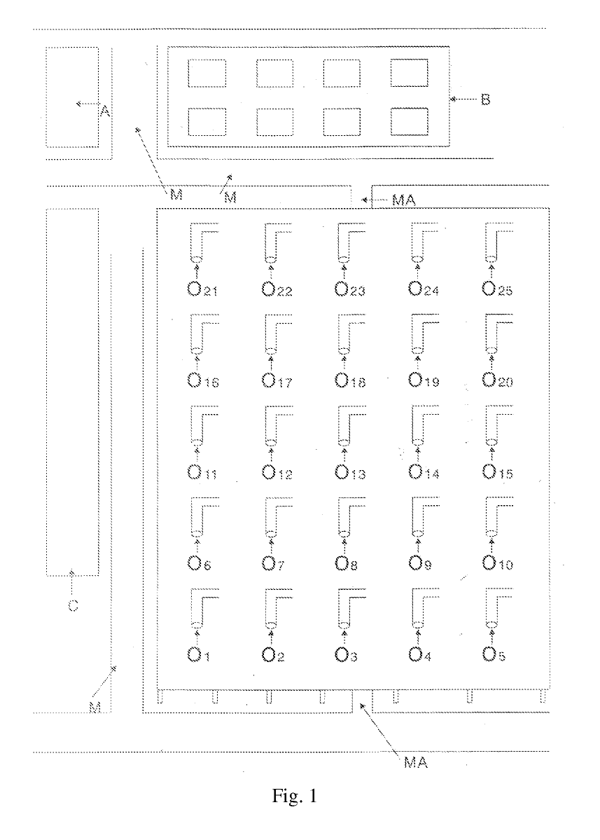

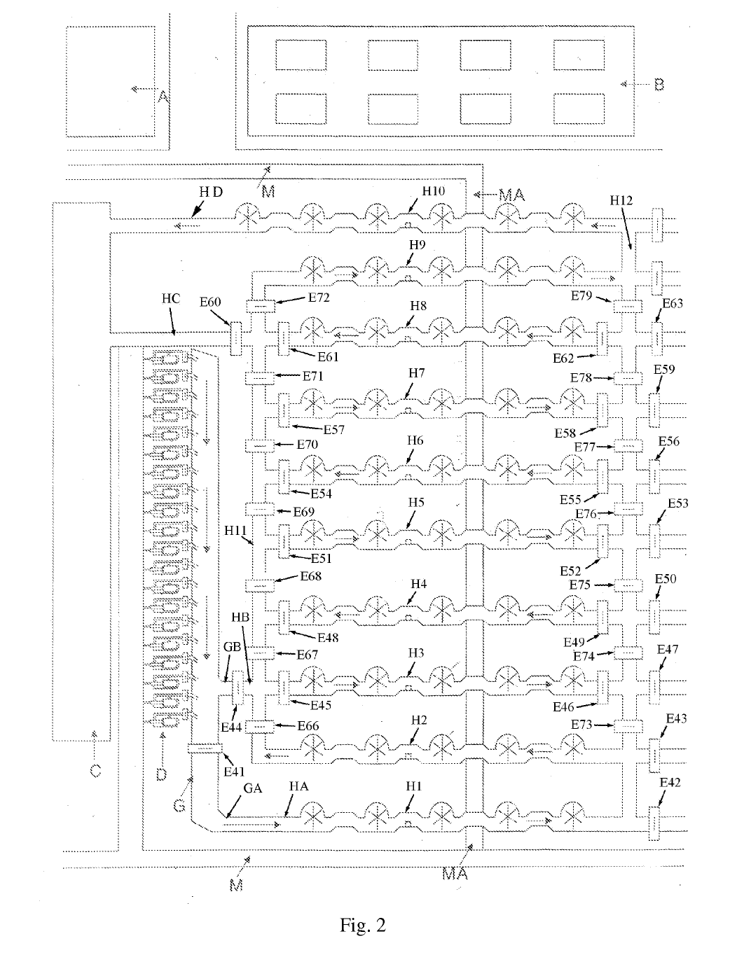

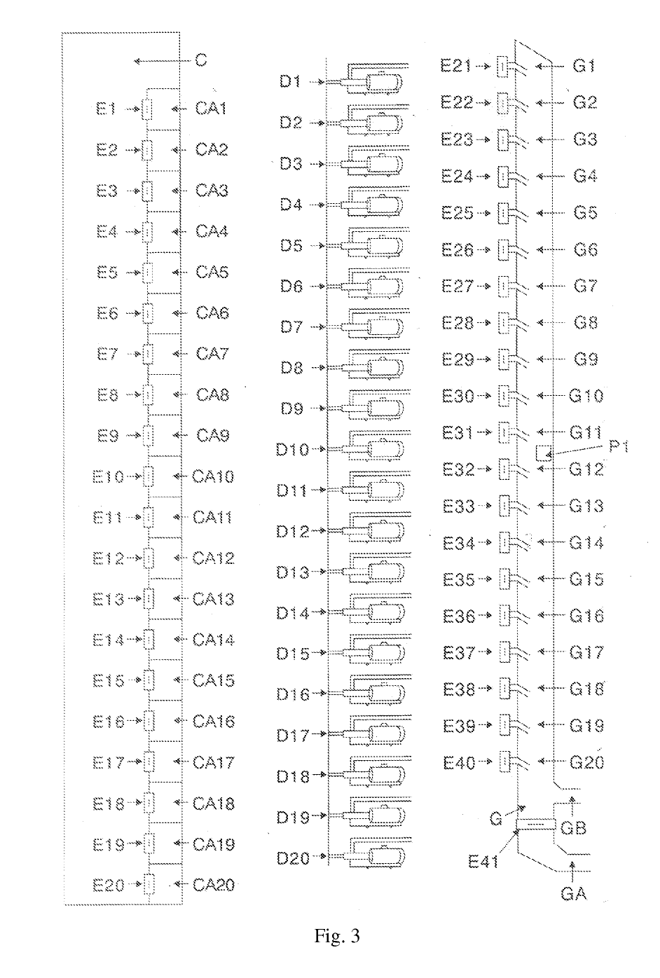

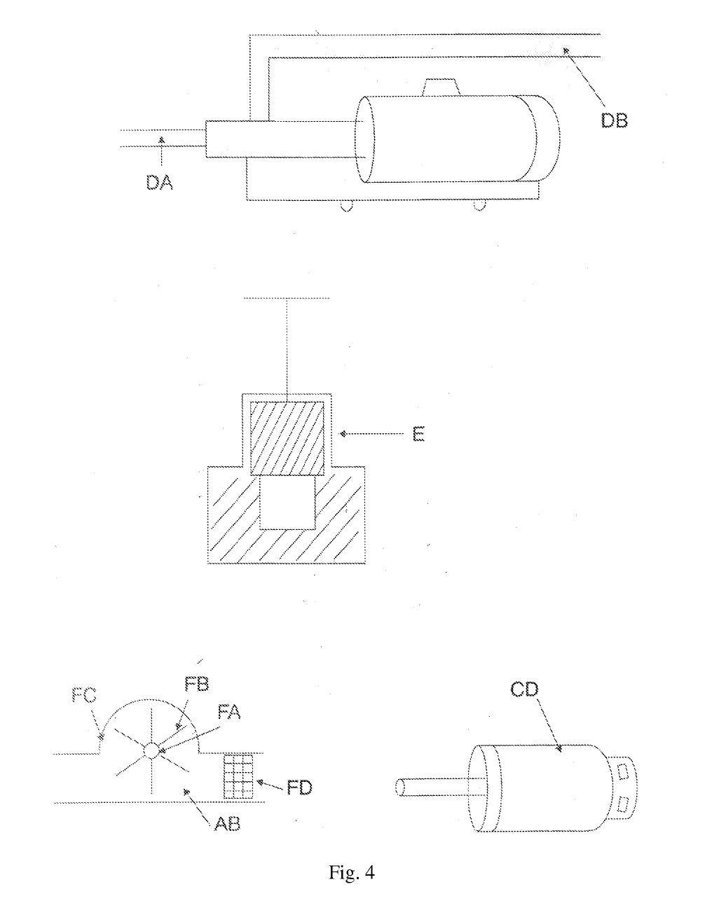

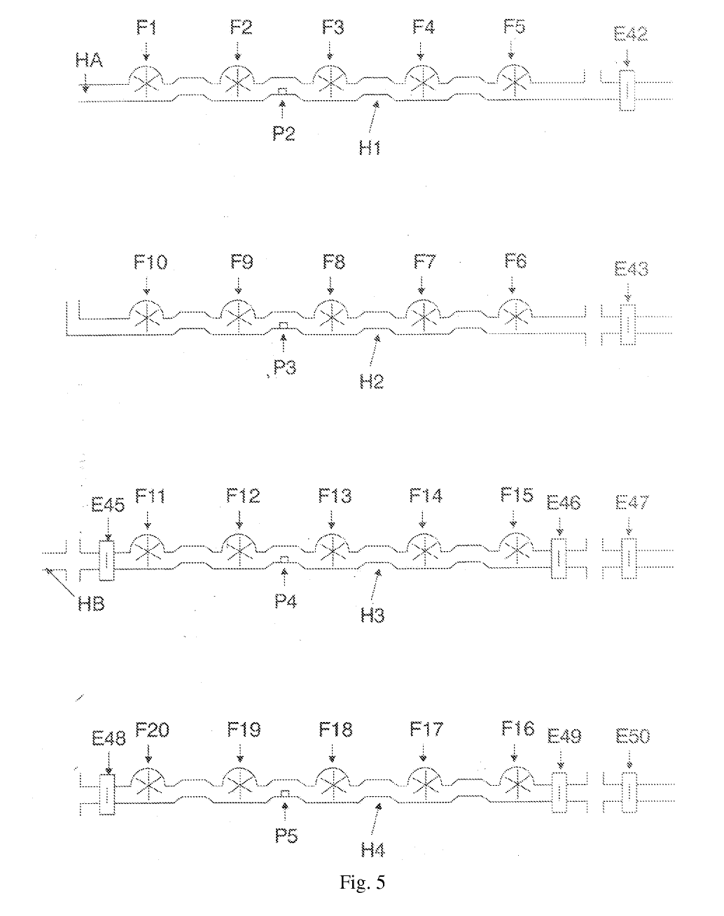

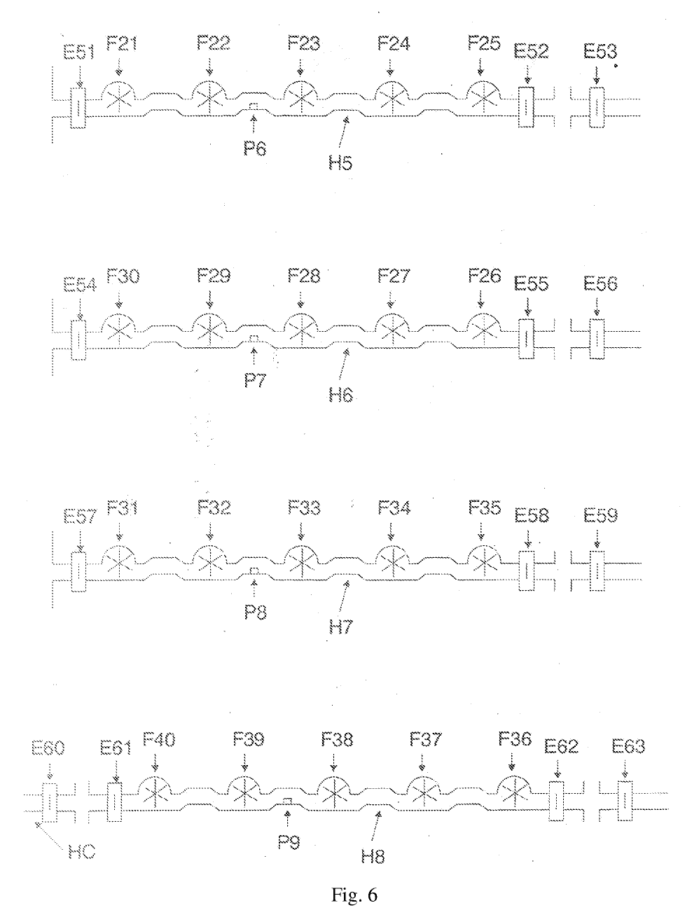

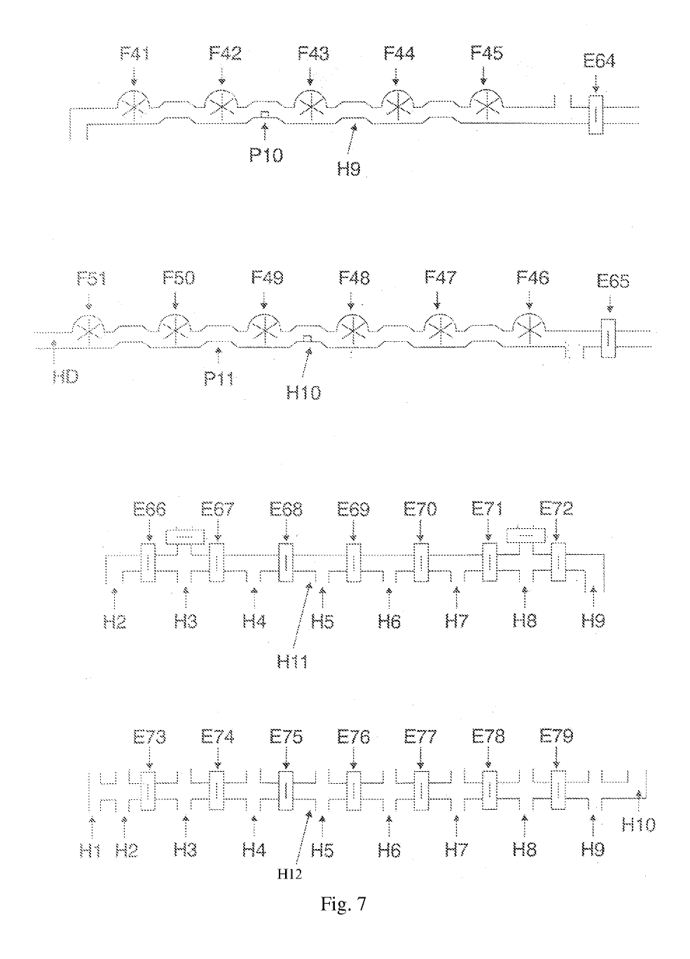

As shown in FIG. 1, FIG. 2, FIG. 3, FIG. 4, FIG. 5, FIG. 6 and FIG. 7, an expandable multi-set circulation hydroelectric power generation method and system according to the present application, comprises a power station control area A, which connects to all the circuits and controls power input and output of a transformer substation area. The power station control area A controls a water pump set station area D, and the power station control area A are also connected to various circuits necessary for water turbine generator sets F in the work done pipes H. The power station control area A functions as a global control station of the whole power station. The transformer substation area B is arranged with a plurality of transformers, which are adapted for input and output of electric energy. In the circulation cistern, a plurality of small cisterns CA1, CA2, CA3, CA4, CA5, CA6, CA7, CA8, CA9, CA10, CA11, CA12, CA13, CA14, CA15, CA16, CA17, CA18, CA19, CA20 are built, having same spec and size. Between the small cisterns and the circulation cistern, protection screenings and gates E1, E2, E3, E4, E5, E6, E7, E8, E9, E10, E11, E12, E13, E14, E15, E16, E17, E18, E19, E20 are arranged for facilitating installation and maintenance of the water pump sets. The water pump set station area D comprises a plurality of water pump sets D1, D2, D3, D4, D5, D6, D7, D8, D9, D10, D11, D12, D13, D14, D15, D16, D17, D18, D19, D20. Inlet pipes DA of the water pump sets D1, D2, D3, D4, D5, D6, D7, D8, D9, D10, D11, D12, D13, D14, D15, D16, D17, D18, D19, D20 are connected to the small cisterns CA1, CA2, CA3, CA4, CA5, CA6, CA7, CA8, CA9, CA10, CA11, CA12, CA13, CA14, CA15, CA16, CA17, CA18, CA19, CA20 in the circulation cistern C, respectively. Roads M are paved above the inlet pipes DA for facilitating installation and maintenance of the water pump set station area D. Outlet pipes DB of the water pump sets D are connected to gates E21, E22, E23, E24, E25, E26, E27, E28, E29, E30, E31, E32, E33, E34, E35, E36, E37, E38, E39, E40 of a pressure pipe G. Inlet pipes G1, G2, G3, G4, G5, G6, G7, G8, G9, G10, G11, G12, G13, G14, G15, G16, G17, G18, G19, G20, which are connected to the pressure pipe G, are then connected to an outlet GA and a standby outlet GB of the pressure pipe G. In the pressure pipe G, also an emergency door P1 and a standby gate E41 are arranged. A standby gate E44 in the standby outlet GB is used for maintenance and extension of the water turbine generator sets in the work done pipes H1 and H2. The work done pipes H1, H2, H3, H4, H5, H6, H7, H8, H9, H10 are concavo-convex pipes, two terminals of which are connected through assistant pipes H11 and H12. The assistant pipes are consisted of straight-through pipes. The assistant pipes are arranged with a plurality of gates, a plurality of branch outlets, and a standby outlet, then the assistant pipes are connected to the work done pipes. The outlet of the work done pipe H1 is connected to the assistant pipe H12, and the inlet HA of the work done pipe H1 is connected to the outlet GA of the pressure pipe G. The work done pipe H1 is provided with water turbine generator sets F1, F2, F3, F4, F5, a standby gate E42 and an emergency door P2, wherein the gate E42 is used for extension purpose. Each water turbine generator set is consisted of a water turbine generator AB and a power generator CD, wherein the water turbine generator AB is consisted of a rotary wheel FA, blades FB, a housing FC and a protection screening FD. Each water turbine generator set may be vertical type or horizontal type generator set. The outlet and the inlet of the work done pipe H2 are connected to the assistant pipe H11 and the assistant pipe H12, respectively. In the work done pipe H2, also water turbine generator sets F6, F7, F8, F9, F10, a gate E43 and an emergency door P3 are built, wherein the gate E43 is used for extension purpose. The inlet and the outlet of the work done pipe H3 are connected to the assistant pipes H11 and H12, respectively. The standby inlet HB of the work done pipe H3 is connected to the standby outlet GB of the pressure pipe G and the gate E44. Water turbine generator sets F11, F12, F13, F14, F15 are built in the work done pipe H3. The work done pipe H3 is connected with a gate E45, a gate E46, a gate E47 and an emergency door P4, wherein the gate E45 and the gate E46 are located at the inlet and the outlet of the work done pipe H3, respectively; switching on/off of the work done pipe H3 is controlled via controlling the gates E45 and E46; and the gate E47 is used for extension purpose. The outlet and the inlet of the work done pipe H4 are connected to the assistant pipes H11 and H12, respectively. In the work done pipe H4, water turbine generator sets F16, F17, F18, F19, F20, gates E48, E49, E50 and an emergency door P5 are arranged, wherein the gate E48 and the gate E49 are located at the inlet and the outlet of the work done pipe H4, respectively; switching on/off of the work done pipe H4 is controlled via controlling the gates E48 and E49; and the gate E50 is used for extension purpose. The outlet and the inlet of the work done pipe H5 are connected to the assistant pipes H11 and H12, respectively. In the work done pipe H5, water turbine generator sets F21, F22, F23, F24, F25, gates E51, E52, E53 and an emergency door P6 are arranged, wherein the gate E51 and the gate E52 are located at the inlet and the outlet of the work done pipe H5, respectively; switching on/off of the work done pipe H5 is controlled via controlling the gates E51 and E52; and the gate E53 is used for extension purpose. The outlet and the inlet of the work done pipe H6 are connected to the assistant pipes H11 and H12, respectively. In the work done pipe H6, water turbine generator sets F26, F27, F28, F29, F30, gates E54, E55, E56 and an emergency door P7 are arranged, wherein the gate E54 and the gate E55 are located at the inlet and the outlet of the work done pipe H6, respectively; switching on/off of the work done pipe H6 is controlled via controlling the gates E54 and E55; and the gate E56 is used for extension purpose. The outlet and the inlet of the work done pipe H7 are connected to the assistant pipes H11 and H12, respectively. In the work done pipe H7, water turbine generator sets F31, F32, F33, F34, F35, gates E57, E58, E59 and an emergency door P8 are arranged, wherein the gate E57 and the gate E58 are located at the inlet and the outlet of the work done pipe H7, respectively; switching on/off of the work done pipe H7 is controlled via controlling the gates E57 and E58; and the gate E59 is used for extension purpose. The outlet and the inlet of the work done pipe H8 are connected to the assistant pipes H11 and H12, respectively. The work done pipe H8 has a standby outlet HC and a standby gate E60, which may be connected to the circulation cistern for being used as a standby outlet. In the work done pipe H8, water turbine generator sets F36, F37, F38, F39, F40, gates E60, E61, E62, E63 and an emergency door P9 are arranged, wherein the gate E61 and the gate E62 are located at the inlet and the outlet of the work done pipe H8, respectively; switching on/off of the work done pipe H8 is controlled via controlling the gates E61 and E62; and the gate E63 is used for extension purpose. The outlet and the inlet of the work done pipe H9 are connected to the assistant pipes H11 and H12, respectively. In the work done pipe H9, water turbine generator sets F41, F42, F43, F44, F45, a gate E64 and an emergency door P10 are arranged, wherein the gate E64 is used for extension purpose. The inlet of the work done pipe H10 is connected to the assistant pipe H12. In the work done pipe H10, water turbine generator sets F46, F47, F48, F49, F50, F51, a gate E65 and an emergency door P11 are arranged, wherein the gate E65 is used for extension purpose. The word done pipe H10 also has a outlet HD being connected to the circulation cistern C. The assistant pipe H11 has gates E66, E67, E68, E69, E70, E71, E72, and the assistant pipe H12 has E73, E74, E75, E76, E77, E78, E79. The gates of the assistant pipes H11 and H12 are located between two adjacent work done pipes, used for connecting or separating the two work done pipes, in such a way the work done pipes are connected together in series. Specifically, the switching on/off state of the gates are: the gates E41, E66, E45, E46, E74, E49, E48, E68, E51, E52, E76, E55, E54, E70, E51, E58, E78, E62, E61, E72 are switched on, i.e., water can flow through them, while the other gates are switched off, i.e., water can not flow through, such that water flow direction as indicated by the arrowhead shown in FIG. 2 is formed. In the normal conditions, all the standby gates are in switching off state. Only when the extension is completed or the standby inlet or outlet is required to use, the corresponding standby gate will be opened, and the other gates will be switched on/off respectively.

When the water turbine generator sets in certain work done pipe (for example H5) are broken down, a corresponding set of work done pipes are switched off through a control of the gates, then the broken work done pipe is cut off. The following discussion is described with reference to the work done pipe H5 as an example, and the other work done pipes are same as it. When the water turbine generator sets in the work done pipe H5 are broken down or need to be maintained, the gates E68, E69 and E70 in the assistant pipe H11, which are located between the work done pipes H4 and H5, between the work done pipes H5 and H6, and between the work done pipes H6 and H7 respectively, are opened, while the inlet of the work done pipe H5 and the gates E51 and E54 at the outlet of the work done pipe H6 are closed, and the gates E75, E76 and E77 in the assistant pipe H12, which are located between the work done pipes H4 and H5, between the work done pipes H5 and H6, and between the work done pipes H6 and H7 respectively, are also closed, in such a way both of the work done pipes H5 and H6 are switched off and detached from the whole system. That is to say, there isn't water flow in the work done pipes H5 and H6, thereby it is convenient for maintenance.

The sectional area of the pressure pipe G is equal to one half of a sum of the sectional areas of the outlets of all the water pumps in operation in the water pump sets, while the sectional area of each work done pipe H is equal to two-third of the sectional area of the pressure pipe. Exhaust pipes O1, O2, O3, O4, O5, O6, O7, O8, O9, O10, O11, O12, O13, O14, O15, O16, O17, O18, O19, O20, O21, O22, O23, O24, O25 are installed on the plant N, and the roads M are built around the plant N, and a underground passage MA is built under the ground of the plant N. Water flow direction Q is marked in the pressure pipe G and the work done pipes H1, H2, H3, H4, H5, H6, H7, H8, H9, H10. The underground drain is connected to the circulation cistern C.

The method and system of the present application may be particularly operated according to the requirements in use, and it can generate electric power when still in construction, thus it does not occupy resources and waste energy. Therefore inexhaustible, recyclable, clear and renewable energy is achieved.

1-10. (canceled)

11. An expandable multi-set circulation hydroelectric power generation method, comprising a power station control area (A), a transformer substation area (B), a circulation cistern (C), and a plant (N) in which a water pump set station area (D) is built, wherein a plurality of water pump sets in the water pump set station area (D) are connected to a plurality of small cisterns (CA) of the circulation cistern (CD), and connected to a pressure pipe (G); the pressure pipe (G) is connected to a plurality to work done pipes (H); the work done pipes are connected to a plurality of gates (E) and then connected to a plurality of water turbine generator sets (F) and emergency doors (P); outlets (HD) of the work done pipes (H) are connected to the circulation cistern (C), characterized in that, the plurality of small cisterns (CA) in the circulation cistern (C) have same size, consisted of in turn the small cisterns (CA1), (CA2), (CA3), (CA4), (CA5), (CA6), (CA7), (CA8), (CA9), (CA10), (CA11), (CA12), (CA13), (CA14), (CA15), (CA16), (CA17), (CA18), (CA19), (CA20); the plurality of gates (E) are consisted of the gates (E1), (E2), (E3), (E4), (E5), (E6), (E7), (E8), (E9), (E10), (E11), (E12), (E13), (E14), (E15), (E16), (E17), (E18), (E19), (E20); the water pump set station area (D) is consisted of the plurality of water pump sets (D1), (D2), (D3), (D4), (D5), (D6), (D7), (D8), (D9), (D10), (D11), (D12), (D13), (D14), (D15), (D16), (D17)(D18), (D19), (D20); inlet pipes (DA) of the water pump sets (D) are connected to the small cisterns (CA) in the circulation cistern (C) via underground, and roads (M) are paved over the inlet pipes (DA); outlets (DB) of the water pump sets (D) are connected to gates (E21), (E22), (E23), (E24), (E25), (E26), (E27), (E28), (E29), (E30), (E31), (E32), (E33), (E34), (E35), (E36), (E37), (E38), (E39), (E40) of the pressure pipe (G), and then connected to inlet pipes (G1), (G2), (G3), (G4), (G5), (G6), (G7), (G8), (G9), (G10), (G11), (G12), (G13), (G14), (G15), (G16), (G17), (G18), (G19), (G20) of the pressure pipe (G); the pressure pipe (G) has an outlet (GA) and a standby outlet (GB); the pressure pipe (G) further has an emergency door (P1) and a gate (41), and the standby outlet (GB) is connected to a gate (E44).

12. The expandable multi-set circulation hydroelectric power generation method according to claim 1, wherein the work done pipes (H1), (H2), (H3), (H4), (H5), (H6), (H7), (H8), (H9), (H10) are consisted of concavo-convex pipes, while the assistant pipes (H11), (H12) are consisted of straight-through pipes, and two terminals of the work done pipes (H1), (H2), (H3), (H4), (H5), (H6), (H7), (H8), (H9), (H10) are connected with the assistant pipes (H11), (H12) respectively to form a series connection; wherein the outlet of the work done pipe (H1) is connected to the assistant pipe (H12), and the inlet (HA) of the work done pipe (H1) is connected to the outlet (GA) of the pressure pipe (G), and the work done pipe (H1) is provided in turn with water turbine generator sets (F1), (F2), (F3), (F4), (F5), a standby gate (E42) and an emergency door (P2); the inlet and the outlet of the work done pipe (H2) are connected to the assistant pipe (H12) and the assistant pipe (H11) respectively, and the work done pipe (H2) is provided in turn with water turbine generator sets (F10), (F9), (F8), (F7) and (F6), a standby gate (E43) and an emergency door (P3); the inlet of the work done pipe (H3) is connected to the standby inlet (GB) of the pressure pipe (G) via a gate (E44), and the inlet and the outlet of the work done pipe (H3) are connected to the assistant pipe (H12) and the assistant pipe (H11) respectively, and the work done pipe (H3) is provided in turn with water turbine generator sets (F11), (F12), (F13), (F14), (F15), and the work done pipe (H3) is provided with gates (E45), (E46), (E47) and an emergency door (P4); the inlet and the outlet of the work done pipe (H4) are connected to the assistant pipe (H12) and the assistant pipe (H11) respectively, and the work done pipe (H4) is provided in turn with water turbine generator sets (F20), (F19), (F18), (F17), (F16), and the work done pipe (H4) is provided with gates (E48), (E49), (E50) and an emergency door (P5); the inlet and the outlet of the work done pipe (H5) are connected to the assistant pipe (H12) and the assistant pipe (H11) respectively, and the work done pipe (H5) is provided in turn with water turbine generator sets (F21), (F22), (F23), (F24), (F24), (F25), and the work done pipe (H5) is provided with gates (E51), (E52), (E53) and an emergency door (P6), the gate (E53) is used for extension purpose; the inlet and the outlet of the work done pipe (H6) are connected to the assistant pipe (H12) and the assistant pipe (H11) respectively, and the work done pipe (H6) is provided in turn with water turbine generator sets (F26), (F27), (F28), (F29), (F30), and the work done pipe (H6) is provided with gates (E54), (E55), (E56) and an emergency door (P7); the inlet and the outlet of the work done pipe (H7) are connected to the assistant pipe (H12) and the assistant pipe (H11) respectively, and the work done pipe (H7) is provided in turn with water turbine generator sets (F35), (F34), (F33), (F32), (F31), and the work done pipe (H7) is provided with gates (E57), (E58), (E59) and an emergency door (P8); the inlet and the outlet of the work done pipe (H8) are connected to the assistant pipe (H12) and the assistant pipe (H11) respectively, the work done pipe (H8) has a standby outlet (HC), and the work done pipe (H8) is provided in turn with water turbine generator sets (F36), (F37), (F38), (F39), (F40), and the work done pipe (H8) is provided with gates (E60), (E61), (E62), (E63) and an emergency door (P9); the inlet and the outlet of the work done pipe (H9) are connected to the assistant pipe (H12) and the assistant pipe (H11) respectively, and the work done pipe (H9) is provided in turn with water turbine generator sets (F41), (F42), (F43), (F44), (F45), and the work done pipe (H9) is provided with a gate (E64) and an emergency door (P10); the inlet of the work done pipe (H10) is connected to the assistant pipe (H12), and the work done pipe (H10) is provided in turn with water turbine generator sets (F51), (F50), (F49), (F48), (F47), (F46), and the work done pipe (H10) is provided with a gate (E65) and an emergency door (P11), and the work done pipe (10) has a outlet (HD) connecting to the circulation cistern (C); the assistant pipe (H11) has gates (E66), (E67), (E68), (E69), (E70), (E71), (E72) which are located between the inlet and the outlet of two adjacent work done pipes respectively; the assistant pipe (H12) has gates (E73), (E74), (E75), (E76), (E77), (E78), (E79) which are located between the inlet and the outlet of two adjacent work done pipes respectively.

13. The expandable multi-set circulation hydroelectric power generation method according to claims 11, wherein the plant (N) is installed with circuits for the gates (E) and the water turbine generator sets (F), and the plant (N) has a plurality of exhaust pipes (O1), (O2), (O3), (O4), (O5), (O6), (O7), (O8), (O9), (O10), (O11), (O12), (O13), (O14), (O15), (O16), (O17), (O18), (O19), (O20), (O21), (O22), (O23), (O24), (O25), around the plant (N), the roads (M) are paved to connect a underground passage (MA); water flow direction indication (Q) is marked on the pressure pipe (G) and the work done pipes (H1), (H2), (H3), (H4), (H5), (H6), (H7), (H8), (H9), (H10); the underground drain is connected to the circulation cistern (C).

14. The expandable multi-set circulation hydroelectric power generation method according to claims 12, wherein the plant (N) is installed with circuits for the gates (E) and the water turbine generator sets (F), and the plant (N) has a plurality of exhaust pipes (O1), (O2), (O3), (O4), (O5), (O6), (O7), (O8), (O9), (O10), (O11), (O12), (O13), (O14), (O15), (O16), (O17), (O18), (O19), (O20), (O21), (O22), (O23), (O24), (O25), around the plant (N), the roads (M) are paved to connect a underground passage (MA); water flow direction indication (Q) is marked on the pressure pipe (G) and the work done pipes (H1), (H2), (H3), (H4), (H5), (H6), (H7), (H8), (H9), (H10); the underground drain is connected to the circulation cistern (C).

15. An expandable multi-set circulation hydroelectric power generation system, comprising a circulation cistern used as water supply, water pump sets, a pressure pipe and work done pipes; wherein:
inlet pipes of the water pump sets are connected to the circulation cistern to pressure up water flow from the circulation cistern, and then the water flow is sent out by the outlet pipes of the water pump sets;
inlets of the pressure pipe are connected to the outlet pipes of the water pump sets to receive the pressured water flow and send it out through an outlet;
each work done pipe has a plurality of water turbine generator sets, wherein an inlet of the work done pipe is connected to the outlet of the pressure pipe to receive the pressured water flow which pushes the water turbine generator sets running, an outlet of the work done pipe is connected to the circulation cistern for water flowing into the circulation cistern via the outlet of the work done pipe.

16. The expandable multi-set circulation hydroelectric power generation system according to claim 15, wherein the circulation cistern comprises a plurality of small cisterns, and a gate is arranged between the circulation cistern and each said small cistern; a number of the water pump sets corresponds to a number of the small cisterns, and the inlet pipe of each of the water pump sets is connected to a corresponding one of the small cisterns.

17. The expandable multi-set circulation hydroelectric power generation system according to claim 15, wherein the work done pipes comprises a plurality of work done pipes, wherein an inlet of the starting work done pipe is connected to the outlet of the pressure pipe via a gate, while an outlet of the final work done pipe is connected to the circulation cistern; two terminals of the other work done pipes are connected to branch outlets of the assistant pipes via gates respectively, and the assistant pipes have gates for separating two adjacent work done pipes of the work done pipes so as to serially connecting the plurality of work done pipes; and each of the work done pipes is provide with power generator sets which are driven by the water turbine generator sets.

18. The expandable multi-set circulation hydroelectric power generation system according to any one of claims 15, wherein sectional area of the pressure pipe is equal to one half of a sum of the sectional area of the outlet pipes of all the water pump sets, and sectional area of the inlet of each work done pipe is equal to two-third of the sectional area of the outlet of the pressure pipe.

19. The expandable multi-set circulation hydroelectric power generation system according to any one of claims 16, wherein sectional area of the pressure pipe is equal to one half of a sum of the sectional area of the outlet pipes of all the water pump sets, and sectional area of the inlet of each work done pipe is equal to two-third of the sectional area of the outlet of the pressure pipe.

20. The expandable multi-set circulation hydroelectric power generation system according to any one of claims 17, wherein sectional area of the pressure pipe is equal to one half of a sum of the sectional area of the outlet pipes of all the water pump sets, and sectional area of the inlet of each work done pipe is equal to two-third of the sectional area of the outlet of the pressure pipe.

21. The expandable multi-set circulation hydroelectric power generation system according to claim 18, wherein the work done pipes are provided with standby gates for bypassing.

22. The expandable multi-set circulation hydroelectric power generation system according to claim 19, wherein the work done pipes are provided with standby gates for bypassing.

23. The expandable multi-set circulation hydroelectric power generation system according to claim 20, wherein the work done pipes are provided with standby gates for bypassing.

24. An expandable multi-set circulation hydroelectric power generation method, comprising: initiating a plurality of water pump sets to draw water from a circulation cistern to a pressure pipe to form pressured water flow; pushing a plurality of water turbine generator sets in a plurality of work done pipes to run by the pressured water flowing into the pressure pipe; driving respective power generator sets running by the water turbine generator sets to generate electric power; returning water flow after power generation into the circulation cistern.

25. The expandable multi-set circulation hydroelectric power generation method according to claim 9, wherein each of said plurality of work done pipes further has a standby gate for extending the water turbine generator sets of the work done pipe.
